(19) United States
(12) Patent Application Publication
(10) Pub. No.: US 2010/0313578 A1
(43) Pub. Date: Dec. 16, 2010

(54) CO2-BASED METHOD AND SYSTEM FOR VAPORIZING A CRYOGENIC FLUID, IN PARTICULAR LIQUEFIED NATURAL GAS

(75) Inventors: Herveline Robidou, Carquefou (FR); Nicolas Bariteau, Nantes (FR)

Correspondence Address: SUGHRUE MION, PLLC, 2100 PENNSYLVANIA AVENUE, N.W., SUITE 800, WASHINGTON, DC, 20037, US

(73) Assignee: GEA Batignolles Technologies Thermiques, Nantes (FR)

(21) Appl. No.: 12/515,227

(22) PCT Filed: Dec. 23, 2008
(86) PCT No.: PCT/FR08/52411

§ 371 Date: May 15, 2009

(30) Foreign Application Priority Data
May 16, 2008 (FR) 0853203

(51) Int. Cl. F17C 9/02; F02C 1/02

(52) U.S. Cl. 62/50.2; 60/407

(57) ABSTRACT

The invention relates to a method for vaporising a cryogenic fluid, in particular liquefied natural gas that comprises the following steps: supplying heat from ambient air to a heat-transfer intermediate fluid in a first heat exchanger (3); supplying heat from said intermediate fluid to the cryogenic fluid in a second heat exchanger (5) in order to vaporise the cryogenic fluid. The intermediate fluid is fed into the second heat exchanger (5) after being compressed, and is fed into the first heat exchanger (3) after the expansion thereof in order to prevent rime formation.

The invention relates to a method of vaporizing a cryogenic fluid, in particular liquefied natural gas (LNG), the method comprising the following steps: delivering heat from the ambient air to a heat transfer intermediate fluid in a first heat exchanger; and delivering heat from said intermediate fluid to the cryogenic fluid in a second heat exchanger so as to vaporize the cryogenic fluid.

The invention is more particularly applicable to a method to be implemented in terminals for vaporizing or for re-gasifying liquefied natural gas in order to vaporize liquefied natural gas that arrives by LNG tanker ship in liquid form at a temperature of about −160 degrees Celsius (° C.) so as to transform it into gas at a temperature lying approximately in the range +2° C. to +20° C., the resulting natural gas then being transported by gas pipelines to its place of use.

A method of vaporizing liquefied natural gas as described above is known in particular from Document U.S. Pat. No. 7,155,917. In that method, the intermediate fluid is in liquid form and it is circulated by means of a pump in a closed-loop circuit passing through heat exchangers. The intermediate fluid is used in the second heat exchanger to vaporize the liquefied natural gas, and, during that vaporization, said intermediate fluid cools. It is then heated in the first heat exchanger by ambient air blown downwards, and that heating cools the ambient air. Frost build-up on the heat exchanger due to the ambient humidity condensing can be limited by an appropriate air flow rate. Unfortunately, the amplitude of the temperature range over which the intermediate fluid is usable for vaporizing the liquefied natural gas is small. Therefore, that method requires a large heat exchange area and thus the installation of an additional circuit and of exchangers that are of very large size.

Another method of vaporizing liquefied natural gas is known, for example, from Document U.S. Pat. No. 5,390,500. That method consists in using ambient air as the intermediate fluid for vaporizing the liquefied natural gas. Unfortunately, that method is not very effective and the amplitude of the air temperature range that is usable for vaporizing the liquefied natural gas is small. That method is thus limited to small or medium size facilities. In addition, that method suffers from the drawback that the condensation of the humidity in the air is transformed into ice when the temperature of the wall of the heat exchanger becomes negative, and that requires the heat exchanger to be provided with de-icing.

An object of the invention is to remedy those drawbacks by proposing a method and a system that use an intermediate fluid for vaporizing a cryogenic fluid on a large scale and that do not give rise to ice build-up.

To this end, the invention provides a method of vaporizing a cryogenic fluid, in particular liquefied natural gas, the method comprising the following steps: delivering heat from the ambient air to a heat transfer intermediate fluid in a first heat exchanger; and delivering heat from said intermediate fluid to the cryogenic fluid in a second heat exchanger so as to vaporize the cryogenic fluid; said method being characterized in that said intermediate fluid is brought into the second heat exchanger after being compressed, and in that it is brought into the first heat exchanger after being expanded.

In particular, the intermediate fluid, which may be carbon dioxide (CO₂), may be compressed to a certain high pressure so as to be brought to a supercritical state, i.e., for CO₂, to a pressure lying approximately in the range 80 bars to 130 bars, and may be expanded to a pressure lying approximately in the range 30 bars to 50 bars. In which case, the carbon dioxide follows a supercritical cycle.

With this method, it is possible to vaporize a cryogenic fluid with a very small heat exchange area, and without ice appearing, thereby making it possible to implement this method in large-size installations. In particular, it is possible, by compression, to bring the intermediate fluid into the second heat exchanger at a temperature that is high enough to vaporize the cryogenic fluid over a small heat exchange area and, by expansion, to bring the intermediate fluid into the first heat exchanger at a temperature that is positive or close to 0° C., slightly lower than the temperature of the ambient air flowing through said heat exchanger, so as to prevent ice appearing on said heat exchanger.

As an intermediate fluid that is well suited to such a compression and expansion process, it is possible to use refrigerant fluids such as propane, carbon dioxide (CO₂), R134a, R152a, or R32, or indeed ammonia, or indeed azeotropic (constant-boiling) mixtures such as ammonia water. CO₂ offers the advantage of having a global warming potential that is considerably lower than the global warming potentials of the other refrigerant fluids, and thus of being less polluting in the event of leakage or of discharge into the environment. CO₂ is also a natural fluid, available in large quantities, is non-inflammable, and has a solidification temperature of about −60° C., which temperature is not reached by the CO₂ during the method of the invention, thereby preventing any risk of solidifying of the second heat exchanger. Also, in the temperature and pressure ranges used in the first heat exchanger, CO₂ has the particular feature of being insensitive to pressure variations, i.e. a small loss of pressure has almost no influence on its temperature. Since it is known that all circuits can leak, the use of CO₂ makes it possible to maintain the temperature almost constant in the first heat exchanger even in situations when pipes leak.

The intermediate fluid can also be maintained in a sub-critical state, characterized by a medium compression, which is less constraining, to pressures lying in the range 40 bars to 60 bars, and then expansion to a pressure lying approximately in the range 30 bars to 35 bars. With this method, the temperature of the carbon dioxide on entering the second heat exchanger is lower but the coefficient of heat exchange at the surface of said heat exchanger is higher due to the fluid condensing.

The invention also provides a system for implementing such a method of vaporizing a cryogenic fluid.

Other characteristics and advantages of the method and of the system of the invention for vaporizing a cryogenic fluid appear more clearly on reading the following description of embodiments and implementations that are illustrated by the drawings, in which:

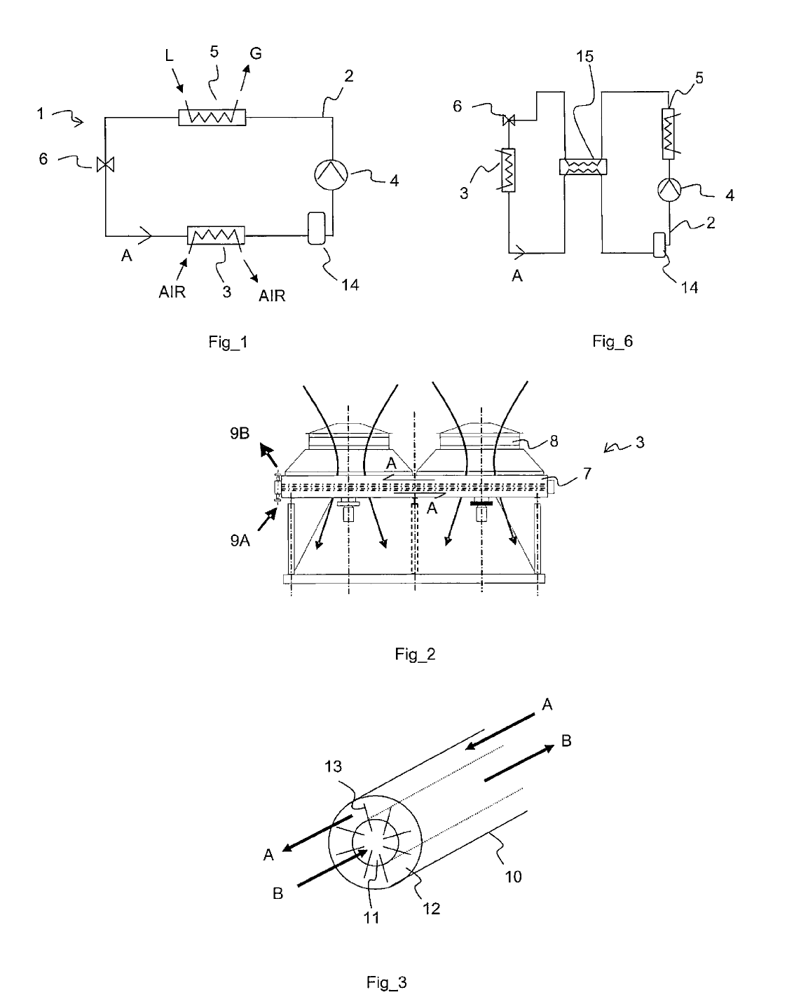

FIG. 1 is a diagram showing the principle of the system of the invention;

FIG. 2 is a diagrammatic section view of a first heat exchanger for vaporizing intermediate fluid and that is used in the system of the invention;

FIG. 3 is a diagrammatic perspective view of a portion of a coaxial tube of a second heat exchanger for vaporizing cryogenic fluid and that is used in the system of the invention;

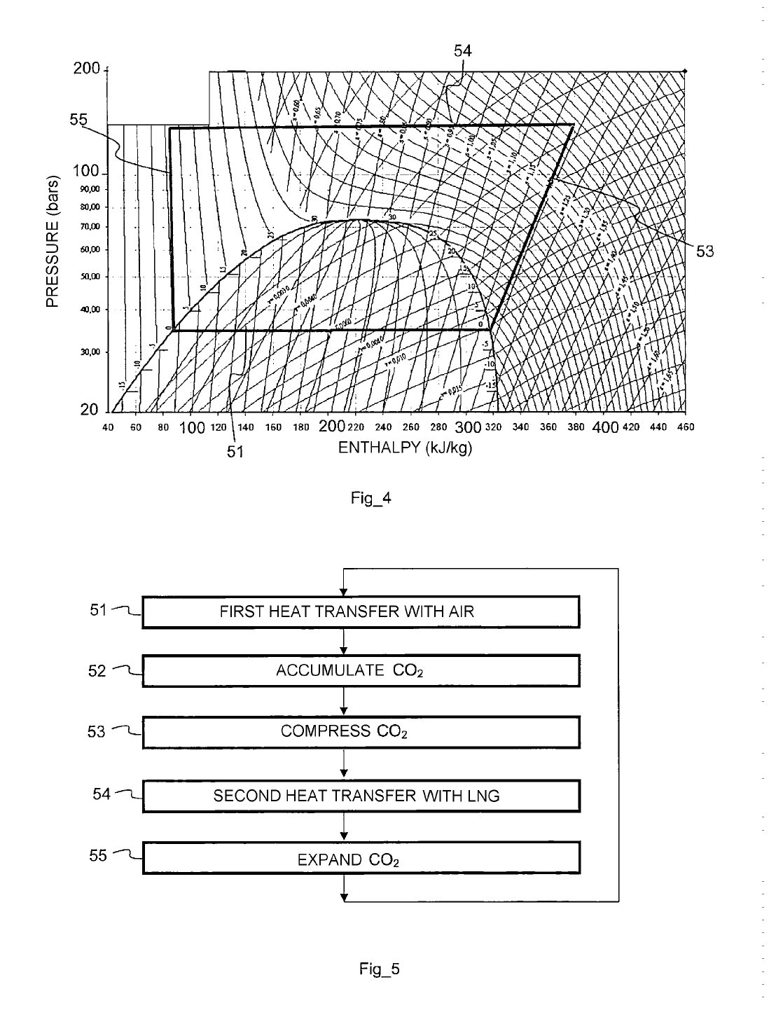

FIG. 4 shows a Mollier diagram for CO₂;

FIG. 5 is a flow chart indicating the steps of the method of the invention;

FIG. 6 is a diagram showing the principle of a variant of the system of the invention; and

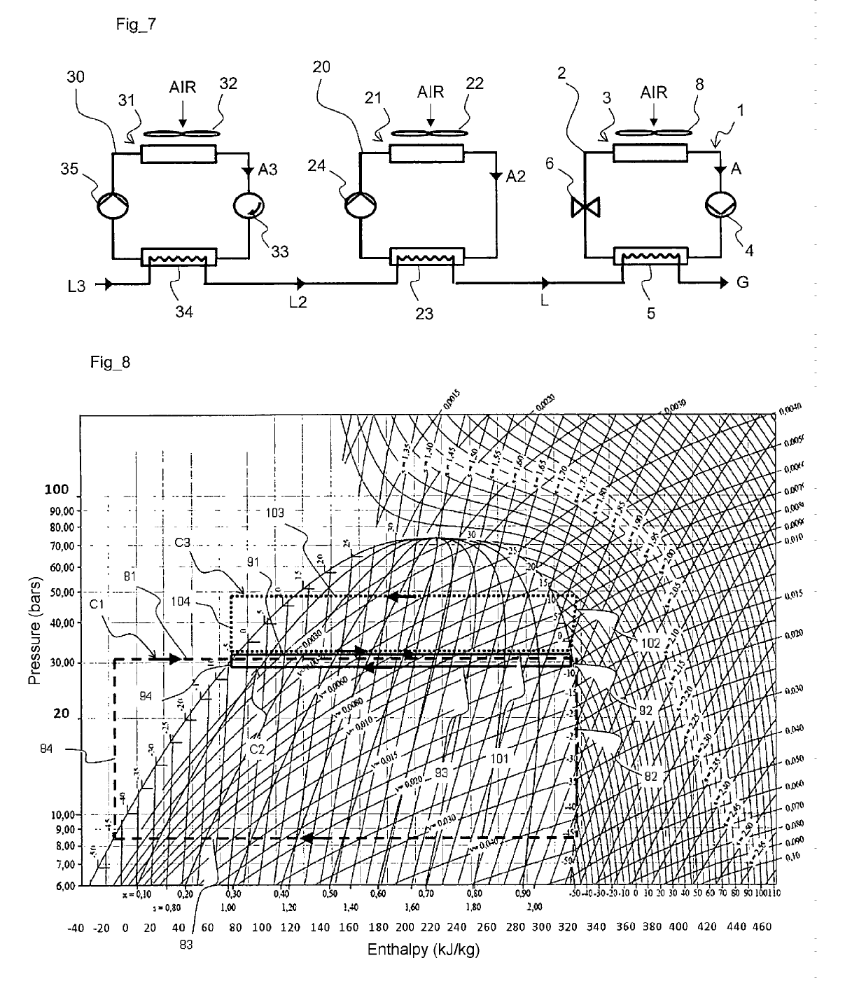

FIG. 7 is a diagram showing the principle of another variant of the system of the invention for vaporizing LNG, this variant having three closed-loop circuits; and

FIG. 8 shows the Mollier diagram for CO₂ with the cycles of the method of the invention in the three closed-loop circuits being indicated.

FIG. 1 is a diagram showing an example of a vaporization system 1 for implementing the method of the invention for vaporizing a cryogenic fluid. In particular, said cryogenic fluid is liquefied natural gas, but naturally the vaporization system 1 could be used for vaporizing some other cryogenic fluid.

The vaporization system 1 of the invention comprises a closed-loop circuit 2 for a heat-transfer intermediate fluid circulating in a certain circulation direction indicated by arrow A in FIG. 1, and that, in the circulation direction A, passes through: a first heat exchanger 3 for heat exchange between ambient air and the intermediate fluid and that is designed to vaporize the intermediate fluid at a constant temperature; a compressor 4 for compressing the intermediate fluid; a second heat exchanger 5 for heat exchange between the intermediate fluid and the cryogenic fluid so as to vaporize said cryogenic fluid; and an expansion member 6 for expanding the intermediate fluid. FIG. 1 shows that ambient air enters and exits from the first heat exchanger 3 by arrows indicating “AIR”, and that the cryogenic fluid enters in the liquid phase and exits in the gas phase from the second heat exchanger 5 by arrows respectively indicating “L” and “G”.

The vaporization system 1 can further comprise an intermediate fluid accumulator device 14 disposed between the first heat exchanger 3 and the compressor 4 and that makes it possible to constitute an intermediate fluid reserve in order to back up operation of the compressor 4 and in order to guarantee that a sufficient quantity of intermediate fluid is present at the inlet of the second heat exchanger 5.

FIG. 2 shows an example of an intermediate fluid heat exchanger 3. It comprises one or more bundles of tubes 7 disposed in a plurality of substantially parallel superposed rows (shown in dashed lines), through which tubes the intermediate fluid flows, and around which tubes the ambient air flows, the ambient air and the intermediate fluid thus not being in direct contact. FIG. 2 indicates the circulation direction A in which the intermediate fluid flows along the tubes 7. The ambient air is blown into the first heat exchanger 3 by one or more fans 8. Humidity contained in the ambient air can condense on the tubes 7 of the first heat exchanger 3 when the surfaces of the tubes 7 are sufficiently cold, and that condensation can be removed from the first heat exchanger 3 by gravity. Preferably, it is chosen to have the fans blow the ambient air downwards, in the same direction as the direction in which the condensation flows so as to facilitate removal thereof.

In this example, the intermediate fluid is injected in the liquid phase into the heat exchanger 3 via one end 9A of the tubes 7, and then it flows in a boiling state through the tubes 7 so that it vaporizes at almost constant temperature and leaves in the gas phase, i.e. in a vaporized state, via another end 9B that is, in this example, adjacent to the intermediate fluid inlet end 9A. Naturally, the superposed configuration of the tubes 7 is shown in FIG. 2 merely by way of non-limiting example. Similarly, the positioning of the motor units of the fans 8 below the bundle of tubes 7 is given merely by way of non-limiting example. Preferably, the motor units of the fans 8 can be placed above the level of the tubes 7 so as to avoid any contact with water. An inclined (rather than perpendicular) configuration could also be chosen for the bundle of tubes 7 relative to the flow of air from the fans 8 so as to make the installation more compact. The intermediate fluid would enter the tubes 7 via a low end 9A and would leave the tubes 7 via a high end 9B that has a level that is much higher than the end 9A.

The tubes 7 of the heat exchanger 3 preferably have through sections that are adapted to limit pressure losses, as a function of whether the intermediate fluid is in the liquid state or in the gas state. For example, it is possible to dispose a first through section made up of a certain number of tubes 7 of a first diameter that are adapted to the liquid intermediate fluid (e.g. a row of ten tubes 7), and then a second through section made up of tubes 7 that are adapted to the gas intermediate fluid and that are of a diameter greater than the first diameter or that are of the same diameter but that are more numerous (e.g. two rows of ten tubes 7) so as to define a greater volume.

The tubes 7 can be made of steel, e.g. stainless steel or carbon steel. They are advantageously provided with external fins and with internal fins of varying shapes (not shown), the external fins facilitating heat exchange between the ambient air and the intermediate fluid, and making it possible to drain the condensation, and the internal fins facilitating boiling of the intermediate fluid by increasing the number of sites of nucleation on the walls of the tubes 7, thereby making it possible to reduce the size of the heat exchanger 3. The external fins are preferably made of aluminum and the spacing between two consecutive fins preferably lies in the range 1.5 mm to 3 mm so as to drain the condensation effectively. The shapes and sizes of the external fins can vary from one tube to another in the bundle of tubes 7. The internal fins can also be replaced with embossing or structured surfaces of the inside walls of the tubes 7. In addition, the outside surfaces of the fins can be treated chemically so as to have water-repellant and anti-corrosion properties so as to facilitate draining of the water, and so as to increase the life time of the installation.

FIG. 3 diagrammatically shows a portion of the second heat exchanger 5 for vaporizing cryogenic fluid. In this example, this heat exchanger is in the form of a coaxial heat exchanger constituted by a set of tubes 10, each of which tubes is made up of two coaxial tubes 11, 12. The cryogenic fluid flows through the inner tube 11 in a direction opposite from the circulation direction A, and indicated by the arrow B in FIG. 3, and the intermediate fluid flows through the outer tube 12 around the inner tube 11 in the circulation direction A. Advantageously, the inner tube 11 of the coaxial heat exchanger 10 can be equipped with fins 13 extending radially between the two tubes 11, 12 in order to facilitate heat exchange between the intermediate fluid and the cryogenic fluid. An insulating material (not shown) can be disposed around the outer tube 12 so as to limit the heat exchange with the ambient air, thereby limiting heat losses.

The second heat exchanger 5 can also be in the form of a heat exchanger of the shell tube type (not shown), or of the plate type (not shown), in a manner generally known to the person skilled in the art, each tube or plate having a different through section adapted to the density of the fluid passing through it (in liquid or gas form in the supercritical state). In these heat exchangers, the respective circulations of the intermediate fluid and of the cryogenic fluid are also countercurrent flows so as to improve the heat exchanges between the two fluids.

Regardless of its shape, the second heat exchanger 5 is preferably made of steel enriched with nickel so as to withstand large temperature variations.

The compressor 4 is chosen as a function of the heat load, of the pressure and temperature ranges and of the flow rate of the intermediate fluid from among commercially available compressors that have been developed recently, e.g. by Dorin, and that are adapted to compress the intermediate fluid within the pressure and temperature ranges of the method, and, in particular for compressing supercritical carbon dioxide going from a temperature lying approximately in the range −10° C. to +15° C. to a temperature lying approximately in the range 100° C. to 150° C. The expansion member 6 can be a valve that is regulated mechanically or electronically.

In accordance with the invention, the heat transfer intermediate fluid can advantageously be carbon dioxide (CO₂) whose thermodynamic properties make it possible to optimize operation of the vaporization system 1 and, in particular, to reduce very considerably the heat exchange area of the second heat exchanger 5 that is necessary for vaporizing the cryogenic fluid. Considering that the CO₂ can enter the second heat exchanger 5 at a temperature of +150° C. and can exit therefrom at a temperature of 0° C., and that the cryogenic fluid can enter said heat exchanger 5 at a temperature of −160° C. and can exit therefrom at a temperature of +2° C., the log mean temperature difference characterizing the heat exchange is 154° C. Whereas, if some other conventional intermediate fluid, e.g. a water-and-glycol mixture, were to be used over a temperature range from about +10° C. on entering the heat exchanger 5 to −7° C. on exiting therefrom, the log mean temperature difference would then be only 49° C. Assuming that said other intermediate fluid has heat exchange properties similar to those of CO₂, that means that a vaporization system 1 of the invention using such another fluid would require a heat exchanger 5 having a heat exchange area that is three times larger. In a variant, for the intermediate fluid, it is possible to use a refrigerant fluid having thermodynamic properties close to those of CO₂ for this method, such as propane, R134a, R152a, or R32.

With reference to FIGS. 4 and 5, a description is given below of the cycle of steps of the vaporization method of the invention, when it is implemented in a system as shown in FIG. 1, while using CO₂ as the intermediate fluid and liquefied natural gas (LNG) as the cryogenic fluid.

FIG. 4 shows the Mollier diagram for CO₂ and in which a typical example of the cycle of steps corresponding to the method of the invention is plotted, and in which the state of the CO₂ at each step is indicated, as shown in FIG. 5.

The method of the invention for vaporizing LNG thus comprises a cycle that starts, at step 51, with a first heat transfer in the first heat exchanger 3, consisting in delivering to the CO₂ heat from the ambient air fed into the heat exchanger 3 at a temperature lying in the range +3° C. to +50° C., the CO₂ entering 9A the heat exchanger 3 finding itself in the liquid phase and at a temperature lying approximately in the range −10° C. to +15° C. During this first step 51 of the method, the heat transfer from the ambient air to the CO₂ makes it possible to vaporize the CO₂ at constant temperature and at constant pressure, as can be seen in FIG. 4, the air exiting from the heat exchanger 3 thereby being cooled. On exiting 9B from the heat exchanger 3, the CO₂ finds itself at a pressure lying approximately in the range 30 bars to 50 bars, and still at a temperature lying approximately in the range −10° C. to +15° C., which means that, even if the humidity from the air condenses on the surface of the heat exchanger 3, the risks of icing are very limited, or even non-existent.

In the first heat exchanger 3, the CO₂ undergoes a change of phase (from its liquid phase to a gas phase) which offers several advantages. Firstly, this makes it possible to increase considerably the heat exchange between the ambient air and the CO₂. In addition, by means of this change of phase, it is possible to control the temperature in the heat exchanger 3 merely by regulating the pressure of the CO₂ exiting from the first heat exchanger 3. Finally, during this change of phase, the CO₂ is insensitive to pressure variations: for example, if the CO₂ undergoes a pressure loss of about 1 bar between entry 9A into and exit 9B from the heat exchanger 3, the temperature is reduced by only 1° C. between the CO₂ entering 9A and exiting 9B from the heat exchanger 3.

On exiting from the heat exchanger 3, the CO₂, in its gas phase, can be accumulated in step 52 in the accumulator device 14, whose size is adapted to match the volume of the intermediate fluid loop 2, before being compressed in step 53 to a pressure lying approximately in the range 80 bars to 130 bars, so as to be heated to a temperature lying approximately in the range +100° C. to +150° C., as can be seen in FIG. 4. Since the pressure of the CO₂ is then greater than the critical pressure, the CO₂ finds itself in its supercritical form.

Then, in step 54, the supercritical CO₂ is brought into the heat exchanger 5 so as to deliver its heat to the LNG that has entered in the liquid phase (seen FIG. 1) at a temperature of about −160° C., in a quantity such that the LNG is vaporized and heated to a temperature lying approximately in the range +2° C. to +20° C. on exiting G from the heat exchanger 5 (see FIG. 1). During this step 54, the CO₂ is cooled to a temperature lying approximately in the range 0° C. to −10° C. by heat transfer from the CO₂ to the LNG, as can be seen in FIG. 4.

Finally, in step 55, the CO₂ is expanded at constant enthalpy to a pressure lying approximately in the range 30 bars to 50 bars in the expansion member 6, as can be seen in FIG. 4. The pressure of the CO₂ at the end of the expansion step 55 is regulated so as to obtain a temperature for the CO₂ that lies approximately in the range −10° C. to +15° C. The method continues by looping back to step 51.

Thus, the temperature of the CO₂ changes approximately over a range +150° C. to −10° C. during a cycle, −10° C. being considerably higher than the solidification temperature of CO₂, which is about −60° C., thereby making it possible to prevent any risk of the CO₂ solidifying in the second heat exchanger 5.

For ambient air temperatures below +5° C., the loss due to the small air temperature amplitude that is usable (between the inlet and the outlet of the first heat exchanger 3) can advantageously be compensated firstly by an increase in the intermediate fluid flow rate in the circuit 2 and secondly by the flow rate of the fans 8 causing the ambient air to flow through the first heat exchanger 3. The method of the invention is thus usable for an ambient air temperature lying in the range +3° C. to +50° C.

For an ambient air temperature of below +3° C., it is possible to provide an additional heater loop (not shown) for heating the intermediate fluid.

In addition, the cooled air exiting from the first heat exchanger 3 can advantageously be used in another heat exchanger for cooling a working fluid (e.g. water) in an electricity generator system (e.g. using a gas turbine).

FIG. 6 shows a variant vaporization system of the invention having an internal heat exchanger 15 interposed between the outlet (via which the intermediate fluid exits) of the heat exchanger 5 (i.e. on the CO₂ high-pressure circuit upstream from the expansion member 6) and the outlet (via which the intermediate fluid exits) of the heat exchanger 3 (i.e. on the CO₂ low-pressure circuit downstream from the compressor 4). The presence of said heat exchanger 15 makes it possible to improve the coefficient of performance (COP) of the CO₂ loop by increasing the quantity of energy usable for heat exchange (this can be understood by the usable enthalpy difference that is larger when this heat exchanger is present in the loop) relative to the energy used for compressing the fluid. In addition, the presence of this heat exchanger 15 enables the CO₂ to enter the compressor 4 at a higher temperature (approximately in the range 10° C. to 20° C.), and thus, for the same compression ratio, to exit from the compressor at a higher temperature (approximately in the range 10° C. to 20° C.). As a result, the CO₂ entering the heat exchanger 5 for vaporizing the cryogenic fluid is at a higher temperature and the heat exchange is more effective, which can enable the heat exchange area to be smaller. The internal heat exchanger 15 can be a coaxial heat exchanger as shown in FIG. 3 with the fluids flowing in countercurrent flow. The CO₂ that finds itself at the higher pressure is ideally fed into the central tube while the CO₂ at low pressure flows through the outer tube surrounding the central tube.

FIG. 7 shows another variant of the vaporization system 1 of the invention that has three closed-loop CO₂ circuits 2, 20, 30 for the heat transfer intermediate fluid, which is CO₂ in this example, circulating in each loop, in a certain circulation direction indicated by a respective one of arrows A, A2, and A3.

In the first closed-loop CO₂ circuit 2, and in the same manner as described above with reference to FIG. 1, in the circulation direction A, the CO₂ passes firstly through the first heat exchanger 3, then through the compressor 4, the second heat exchanger 5, and the expansion member 6. The ambient air passing through the first heat exchanger 3 is represented by an arrow indicating AIR, and the cryogenic fluid, which is LNG in this example, entering the second heat exchanger 5 in liquid or supercritical phase, and exiting therefrom in the gas phase, is represented by arrows respectively indicating L and G.

The purpose of the first circuit 2 is to vaporize the LNG by means of heat exchange with the CO₂ compressed in the compressor 4, and to obtain LNG at a positive temperature at the outlet G, as in the method described above with reference to FIG. 5.

In a second closed-loop CO₂ circuit 20 upstream from the first CO₂ circuit 2, and in the circulation direction A2, the CO₂ passes through a fourth heat exchanger 21 for exchanging heat between the ambient air and the CO₂, a fifth heat exchanger 23 for exchanging heat between the CO₂ and the LNG, and a pump 24 of the electric type or of some other type. The CO₂ is brought from the fourth heat exchanger 21 to the fifth heat exchanger 23 via conventional pipes that are known per se by the person skilled in the art. In this example, the fifth heat exchanger 23 is connected in series with the second heat exchanger 5 so as to preheat the LNG, the LNG (in liquid or supercritical phase) entering the fifth heat exchanger 23 being represented in FIG. 7 by an arrow indicating L2, and the heated LNG (still in liquid or supercritical phase) exiting from the fifth heat exchanger 5 being indicated by arrow L.

The second circuit 20 makes it possible to preheat the LNG by heat exchange with the CO₂ with low electricity consumption and optimized cost. The LNG arrives in the first circuit 2 at L, thereby making it possible to reduce the range of compression of the CO₂ that is necessary in order to achieve a CO₂ pressure and a CO₂ temperature sufficient to vaporize the LNG.

In a third closed-loop CO₂ circuit 30, upstream from the second CO₂ circuit 20, and in the circulation direction A3, the CO₂ passes through a sixth heat exchanger 31 for exchanging heat between the ambient air and the CO₂, a turbine 33 suitable for using a CO₂ pressure difference to generate electrical energy, a seventh heat exchanger 34 for exchanging heat between the CO₂ and the LNG, and a pump 35 of the electric type or of some other type. In this example, the seventh heat exchanger 34 is connected in series with the fifth heat exchanger 23 so as to preheat the LNG another time, the LNG (in the liquid phase) entering the seventh heat exchanger 34 being represented in FIG. 7 by an arrow indicating L3, and the heated LNG (in liquid or supercritical phase) exiting from said seventh heat exchanger 34 being indicated by arrow L2.

The third circuit 30 makes it possible to preheat the LNG while also using the CO₂ pressure difference in the cycle to cause the turbine 33 to turn and generate electrical energy, which energy can be used in various portions of the system 1 (pumps, compressors, fans, etc.).

In each circuit 2, 20, 30, the ambient air is blown through the heat exchangers 3, 21, 31 by respective fans 8, 22, 32 at the arrow indicating AIR in FIG. 7.

With reference to FIG. 8 that shows a Mollier diagram for CO₂, a description is given below of three cycles of steps C1, C2, and C3 of the vaporization method of the invention, when it is implemented in a system as shown in FIG. 7 and comprising three closed-loop circuits 2, 20, 30, while using CO₂ as the intermediate fluid, and LNG as the cryogenic fluid. It can be understood that the vaporization system 1 of the invention preferably operates with all three closed-loop circuits 2, 20, 30, but it can also operate with the first and second closed-loop circuits 2, 20 only, or indeed with the first circuit 2 only, as explained below.

The liquid LNG is fed firstly into the third circuit 30 at a temperature of about −160° C. and at a pressure of about 90 bars into the seventh heat exchanger 34, at the arrow L3 in FIG. 7, so as to be heated by heat exchange with the CO₂ in the heat exchanger 34 to a temperature lying in the range −55° C. to −30° C. at the outlet L2, the LNG then being in a supercritical state.

In the third circuit 30, the CO₂ undergoes a cycle C1 (shown in dashed lines in FIG. 8) starting at step 81 with heat transfer in the heat exchanger 31 consisting in delivering heat from the ambient air fed into the heat exchanger 31 at a temperature of at least +5° C. to the CO₂ finding itself at the inlet of the heat exchanger 31 in the liquid phase at a temperature lying approximately in the range −5° C. to 0° C. and at a pressure lying in the range 30 bars to 35 bars. Like the purpose of the above-described step 51, the purpose of this step 81 is to vaporize the CO₂ at constant temperature and at constant pressure, as can be seen in FIG. 8, the air exiting from the heat exchanger 31 consequently being cooled.

On exiting from the heat exchanger 31, the gas CO₂ is brought into the turbine 33 in which the CO₂ undergoes, at step 82, a pressure reduction to approximately in the range 7 bars to 15 bars and a temperature reduction to approximately in the range −50° C. to −25° C. The CO₂ pressure difference in the turbine is thus large, thereby making it possible to recover a large quantity of electrical energy.

Then, the gas CO₂ is brought into the seventh heat exchanger 34 so that, in step 83, it delivers heat and heats the liquid LNG that has entered the heat exchanger 34 at L3. During the step 83, the CO₂ goes from the gas state to a liquid state, at constant temperature and at constant pressure.

Finally, in step 84, the CO₂ is pumped towards the sixth heat exchanger 31, so that its pressure increases to approximately in the range 30 bars to 35 bars and its temperature increases to approximately in the range −5° C. to 0° C., and the CO₂ finds itself in the liquid state. The method continues by looping back to step 81.

After going through this circuit 30, the supercritical LNG exits from the seventh heat exchanger 34 at L2 so as to be fed into the second circuit 20, where it is heated by heat exchange with the CO₂ in the fifth heat exchanger 23 until it reaches a temperature lying in the range −15° C. to −7° C. at the outlet L of the heat exchanger 23, the LNG then being in a supercritical state.

In said second circuit 20, the CO₂ undergoes a cycle C2 (shown in continuous lines in FIG. 8) starting at step 91, as in above-described step 81, with heat transfer in the fourth heat exchanger 21 consisting in delivering heat from the ambient air fed into the heat exchanger 21 at a temperature of at least +5° C. to the CO₂, which CO₂ is liquid on entering the heat exchanger 21 at a temperature lying approximately in the range −5° C. to 0° C., and at a pressure lying in the range 30 bars to 35 bars. This step 91 makes it possible to vaporize the CO₂ at constant temperature and at a constant pressure, the air exiting from the heat exchanger 21 being cooled.

On exiting from the heat exchanger 21, the CO₂ in the gas phase is brought in step 92 to the fifth heat exchanger 23 in pipes in which the CO₂ undergoes a small pressure loss to approximately in the range 25 bars to 33 bars, and a temperature reduction to approximately in the range −10° C. to −2° C. In the fifth heat exchanger 23, and in step 93, the CO₂ delivers heat and heats the liquid LNG that has entered at L2 into the heat exchanger 23. In said step 93, the CO₂ goes from the gas state to a liquid state, at constant temperature and at constant pressure. Finally, in step 94, the CO₂ is pumped towards the fourth heat exchanger 21 and goes from the gas state to the liquid state, its pressure increases to approximately in the range 30 bars to 35 bars, and its temperature increases to approximately in the range −5° C. to 0° C. The method continues by looping back to step 91.

At the outlet of the circuit 20, the supercritical LNG exits from the fifth heat exchanger 23 at L at a temperature lying approximately in the range −15° C. to −7° C. so as to be fed into the first circuit 2 where it is heated and vaporized by heat exchange with the CO₂ in the second heat exchanger 5 until it reaches a temperature lying in the range 0° C. to +15° C. on exiting G from the heat exchanger 5.

In the first circuit 2, the CO₂ undergoes a cycle C3 (shown in dashed lines in FIG. 8) starting at step 101, as in above-described step 81 or step 91, with heat transfer in the first heat exchanger 3 consisting in delivering heat from the ambient air fed into the heat exchanger 3 at a temperature of at least +5° C. to the CO₂, which CO₂ is liquid on entering the heat exchanger 3 at a temperature lying approximately in the range −5° C. to 0° C., and at a pressure lying in the range 30 bars to 35 bars. This step 101 makes it possible to vaporize the CO₂ at constant temperature and at a constant pressure, the air exiting from the heat exchanger 3 being cooled.

On exiting from the heat exchanger 3, the CO₂ in the gas phase is compressed in step 102 to a pressure lying approximately in the range 40 bars to 60 bars, so as to be heated to a temperature lying approximately in the range 5° C. to 20° C. The CO₂ is then brought into the heat exchanger 5 so that, in step 103, it delivers heat to the LNG that has entered at L at a temperature of about −15° C., in a quantity such that the LNG is vaporized and heated to a temperature lying approximately in the range 0° C. to +15° C. at the outlet G of the heat exchanger 5. In step 103, the CO₂ goes from the gas state to a liquid state, at constant temperature and at constant pressure. Finally, the CO₂ is brought to the expansion member 6 so as to be expanded in step 104 at constant enthalpy to a pressure lying approximately in the range 30 bars to 35 bars, and a temperature lying approximately in the range −5° C. to 0° C. The method continues by looping back to step 101.

In the first CO₂ circuit 2, the CO₂ can also undergo a “supercritical” cycle as described above with reference to FIG. 4.

During the method of the invention, the LNG pressure is regulated so as to remain almost constant and so as to decrease only from about 90 bars at the inlet L3 of the third circuit 30 to about 88 bars at the outlet G of the first circuit 2.

The advantage of this method in three successive cycles C1, C2, C3 is that it makes it possible, by reducing the CO₂ compression range in step 102 (relative to the step 53 of the method described above with reference to FIG. 5), to reduce considerably the electrical energy consumption in the cycle C3. The circuit C2 makes it possible to bring LNG into the circuit C3 at a temperature that is high enough to make this reduction in CO₂ compression possible. Finally, the advantage of the circuit C1 is to make it possible to use a fraction of the energy from the CO₂ to generate electricity, thereby reducing the energy dependence of the other circuits C2, C3. The combined set of circuits C1, C2, C3 consumes less energy and is more effective than the circuit C3 alone.

It is possible to implement the method of the invention in the circuits C2, C3 only, with the same pressure and temperature ranges for the CO₂ at each step. In which case, the LNG is fed directly at L2 into the fifth heat exchanger 23 of the circuit C2 at a temperature of about −160° C., and exits at L at a temperature lying approximately in the range −15° C. to −7° C. before being fed into the second heat exchanger 5. Since the circuit C2 is a circuit without a compressor, with a conventional pump 24, the total cost of the circuits C2 and C3 is advantageous relative to the cost of the circuit C3 alone.

It is also possible to implement the method of the invention in the circuit C3 alone with the same pressure and temperature ranges for the CO₂ at each step. In which case, the LNG is fed directly at L into the second heat exchanger 5 of the circuit C3 at a temperature of about −160° C., and exits as vaporized at G at a temperature lying approximately in the range 0° C. to +15° C. This method makes it possible to consume less energy than the method described above with reference to FIGS. 1 and 4 that requires the CO₂ to be compressed to at least about 80 bars.

It can be understood that the fourth and sixth heat exchangers 21, 31 for exchanging heat between the air and the CO₂ are similar to the first heat exchanger 3, and that the fifth and seventh heat exchangers 23, 34 for exchanging heat between the LNG and the CO₂ are similar to the second heat exchanger 5.

1. A method of vaporizing a cryogenic fluid, in particular liquefied natural gas, the method comprising the following steps:
delivering heat from the ambient air to a heat transfer intermediate fluid in a first heat exchanger; and
delivering heat from said intermediate fluid to the cryogenic fluid in a second heat exchanger so as to vaporize the cryogenic fluid;
said method being characterized in that said intermediate fluid is brought into the second heat exchanger after being compressed, and in that it is brought into the first heat exchanger after being expanded.

2. A method of vaporizing a cryogenic fluid according to claim 1, wherein the intermediate fluid is chosen from among refrigerant fluids such as propane, carbon dioxide (CO₂), R134a, R152a, or R32.

3. A method of vaporizing a cryogenic fluid according to claim 1, wherein the intermediate fluid is compressed to a certain high pressure so as to be brought to a supercritical state, i.e., for CO₂, to a pressure lying approximately in the range 80 bars to 130 bars, and is expanded to a pressure lying approximately in the range 30 bars to 50 bars.

4. A method of vaporizing a cryogenic fluid according to claim 1, wherein the intermediate fluid is compressed to a certain medium pressure so as to be maintained in a sub-critical state, i.e., for CO₂, a pressure lying approximately in the range 40 bars to 60 bars, and is expanded to a pressure lying approximately in the range 30 bars to 35 bars.

5. A system for vaporizing a cryogenic fluid, in particular liquefied natural gas, the system comprising, in a closed-loop circuit for an intermediate fluid circulating in a certain circulation direction, a first heat exchanger for exchanging heat between the ambient air and said intermediate fluid so as to deliver heat to the intermediate fluid, and a second heat exchanger for exchanging heat between the intermediate fluid and said cryogenic fluid so as to vaporize the cryogenic fluid, said system being characterized in that it further comprises a compressor for compressing said intermediate fluid, which compressor is disposed in the circulation direction between the first and the second heat exchangers and an expansion member for expanding said intermediate fluid, which expansion member is disposed in the circulation direction between the second and the first heat exchangers.

6. A system for vaporizing a cryogenic fluid according to claim 5, further comprising an accumulator device for accumulating intermediate fluid, which accumulator device is disposed in the circulation direction between the first heat exchanger and the compressor.

7. A system for vaporizing a cryogenic fluid according to claim 5, wherein the first heat exchanger has a bundle of tubes disposed in a plurality of rows and provided with external fins, and optionally with internal fins.

8. A system for vaporizing a cryogenic fluid according to claim 7, wherein the heat exchanger has fans arranged to cause the ambient air to flow downwards around said tubes.

9. A system for vaporizing a cryogenic fluid according to claim 5, wherein the second heat exchanger is of the type having coaxial tubes provided with fins, or having a shell tube or plates.

10. A system for vaporizing a cryogenic fluid according to claim 5, in which a third heat exchanger is interposed between an outlet of the second heat exchanger and an outlet of the first heat exchanger.

11. A system for vaporizing a cryogenic fluid according to claim 5, further comprising a second closed-loop circuit for the same intermediate fluid with a fourth heat exchanger for exchanging heat between the ambient air and the intermediate fluid, and a fifth heat exchanger for exchanging heat between the intermediate fluid and said cryogenic fluid, said fifth heat exchanger being connected in series with the second heat exchanger in order to pre-heat said cryogenic fluid.

12. A system for vaporizing a cryogenic fluid according to claim 11, further comprising a third closed-loop circuit for the same intermediate fluid with a sixth heat exchanger for exchanging heat between the ambient air and said intermediate fluid, a seventh heat exchanger for exchanging heat between the intermediate fluid and said cryogenic fluid, and a turbine suitable for using a pressure difference in said intermediate fluid to generate electrical energy, said seventh heat exchanger being connected in series with the fifth heat exchanger so as to preheat said cryogenic fluid another time.
